(19) United States
(12) Patent Application Publication
(10) Pub. No.: US 2013/0154823 A1
(43) Pub. Date: Jun. 20, 2013

(54) Alarm Detection and Notification System

(71) Applicant: L&O Wireless, Inc., Sunnyvale, CA (US)

(72) Inventors: Aharon Ostrer, Sunnyvale, CA (US); Lavi Lev, Saratoga, CA (US)

(73) Assignee: L&O WIRELESS, INC., Sunnyvale, CA (US)

(21) Appl. No.: 13/721,112

(22) Filed: Dec. 20, 2012

Related U.S. Application Data
(60) Provisional application No. 61/577,765, filed on Dec. 20, 2011.

(51) Int. Cl. G08B 21/18

(52) U.S. Cl. CPC G08B 21/18
USPC 340/539.1

(57) ABSTRACT

There is provided an apparatus having a controller generates a signal in response to receiving an alarm indication from a sensor, the alarm indication indicative of an alert condition threatening lives or property. A transmitter directly transmits a message signal in response to the signal generated by the controller to a remote telecommunication device that is operated by a user. The controller, the sensor, the alert condition and the transmitter are all on-site in the same location.

### RELATED PATENT APPLICATION

This application claims the benefit of U.S. Provisional Application 61/577,765 filed on Dec. 20, 2011, and entitled “Alarm Detection and Notification System”, which is incorporated herein by reference for all purposes.

### BACKGROUND

Smoke and Carbon Monoxide (CO) detectors perform an important service by saving lives of building occupants, by detecting fires and/or poisonous gases, and by sounding an audible alarm. But when building occupants are not present or otherwise incapacitated, many smoke or CO detectors are useless as nobody hears the alarm or acts upon it and fire and poisonous gas expand unchecked, causing significant property damage and threatening lives Some available alarm systems attempt to address this issue by deploying an expensive and complicated array of special dedicated smoke and/or CO detectors. These are hard wired or otherwise interconnected to a central control system, which notifies third party dedicated personnel who in turn notifies the remote user or emergency services. Such system requires expensive professional installation and a subscription for the service.

Other systems exist which comprise an intelligent smoke detector with an ability to provide notification to the remote user directly through a cellular phone service. Such systems require replacing existing smoke detectors with a dedicated intelligent device. As National Fire Protection Association (NFPA) codes require smoke detectors in each bedroom and on every floor, there are usually several smoke detectors in the building. Replacing legacy smoke detectors with dedicated intelligent devices is complicated and expensive. These systems also require purchasing and maintaining SIM cards and contracts with cellular providers.

Systems exist that listen to existing installed smoke detectors and transmit alarm indication to a remote server or computer system, owned and/or operated by a third party, thus without direct control of the user. This third party remote server makes a judgment and a decision to notify the subscribed user of an alarm condition. These systems necessarily introduce a delay to the user notification of a potentially life or property threatening condition, while requiring paid subscription for a third party service. In addition, user is required to disclose personal data to a third party operator without any guarantee of a security and reliability of an unknown remote server and without direct control of a notification parameters.

### SUMMARY

There is provided an apparatus having a single onsite controller that generates a signal in response to receiving an alarm indication from a sensor, the alarm indication indicative of an alert condition threatening lives or property. A telecommunication transmitter directly transmits a message signal in response to the signal generated by the controller to a remote telecommunication device that is operated by a user wherein the controller, the sensor, the alert condition and the transmitter are all on-site in the same location and wherein the notification decision is made on-site in the same location.

### BRIEF DESCRIPTION OF THE DRAWINGS

FIG. 1: Provides a Block diagram of a complete example system, comprising one controller and one or more sensors.

FIG. 2: Provides a Block diagram of an example sensor, comprising Alarm Sound Detector and wireless transmitter/receiver.

FIG. 3: Provides a Block diagram of the example controller with various embodiments of the Telecommunication Transmitter

FIG. 4: Provides an example of a Standard smoke detector alarm audible pattern waveform—T3 (Temporal Three) pattern, as defined by NFPA 72 National Fire Alarm and Signaling code and ANSI 53.41 standard for the post-1996 smoke detectors.

FIG. 5: Provides an example of a Standard CO detector alarm audible pattern waveform—T4 (Temporal Four) pattern, as defined by NFPA 720 Standard for the Installation of Carbon Monoxide(CO) Detection and Warning Equipment.

FIG. 6: Provides an example of a Sound alarm alert decision algorithm, applicable to smoke or CO detectors.

FIG. 7: Provides an example of a Learning Mode (Calibration) and System Test algorithm, which allows adaptation to sound alarm level at various distances from a smoke or CO detector along with testing of the system by measuring ambient noise.

FIG. 8: Provides an example overview of an alarm detection and notification system.

FIGS. 9a-d: Provide various examples of system components and programming screens.

### DESCRIPTION

A detailed description of the various aspects of the invention shall now be set forth. In one aspect, a controller is provided. The controller generates a signal in response to receiving an audible alarm indication from a sensor. The audible alarm is indicative of an alert condition threatening lives or property. A telecommunication transmitter directly transmits a message signal in response to the signal generated by the controller to a remote telecommunication device that is operated by a user who has a nexus with the lives or property that are threatened or by a person designated by a user.

In another aspect the alarm condition is detected by a sensor that detects an audible alarm.

In another aspect the sensor includes a wireless transmitter that transmits an audible alarm indication from the sensor to the controller.

In another aspect, there is provided a telecommunication transmitter that directly transmits a message signal in response to the signal generated by the controller to a remote telecommunication device that is operated by a user or by a person designated by a user. The user, for example, may have a nexus with the lives of people, pets or property that are threatened.

In one aspect, the message signal includes routing information necessary to route the message signal to the telecommunication device.

In another aspect, the routing information routes the message signal over a telecommunications network selected from the group consisting of: EDGE, GSM, GPRS, 3G, 4G, Internet, PTSN and other protocols, for example.

In another aspect, the message signal is configured to have a format appropriate for a telecommunications message, the format selected from the group consisting of: a cell phone text message, a mobile phone short message service (SMS), an email, a telephone message and a twitter message.

In another aspect, the telecommunication transmitter is selected from the group consisting of: a cellular transmitter, a phone dialer, a computer device (e.g. PC) connected to the Internet through, for example, a DSL gateway or a cable gateway or a dial up modem.

In another aspect, a sensor is provided which senses and detects the audible alarm. The sensor includes a wireless transmitter that transmits a wireless signal to the controller in response to detecting the audible alarm.

In another aspect, logic and/or algorithm is provided which determines that the audible alarm conforms to a specific alarm protocol as defined by governmental and/or industrial standards.

In another aspect, the sensor is configured to determine that the audible sound corresponds to a standardized alarm selected from the group consisting of: National Fire Protection Association (NFPA), an American National Standards Institute (ANSI), and Underwriters Laboratories (UL) or other governmental or industrial organizations defining life threatening alarms.

In another aspect, the sensor is configured to determine that the audible sound corresponds to an alarm selected from the group consisting of an NFPA 72 signaling code, an NFPA 720 standard, an ANSI S 3.41 standard, and a UL 217 standard or other governmental and/or industrial standards defining life threatening alarms.

In another aspect, the sensor is configured to determine that the audible sound corresponds to an alarm from a past, present or future generation of alarm.

In another aspect, learning logic adjusts a detection parameter based on an environmental condition affecting the audible alarm.

In another aspect, the controller is arranged in a first housing.

In another aspect, the sensor is arranged in a second housing as a relay, separate from the first housing.

In another aspect, a plurality of sensors are dispersed throughout a given area where said lives or property are threatened.

In another aspect, the sensor employs a low power wireless transmitter to transmit the alarm detection signal in order to save power.

In another aspect, logic is provided that keeps most of the sensor circuit in inactive state in order to save power.

In another aspect, the controller can control and communicate with heterogeneous plurality of various sensors such as smoke alarm, burglar alarm, temperature alert, flood alarm and others.

There is provided in addition or in the alternative a method including detecting that an emitted audible alarm is indicative of an alert condition threatening lives or property and directly transmitting a message signal in response to detecting the audible alarm to a remote telecommunication device that is operated by a user.

In another aspect, routing information is included that is associated with the message signal necessary to route the message signal to the telecommunication device.

In another aspect, the routing information routes the message signal over a telecommunications network selected from the group consisting of: EDGE, GSM, GPRS, 3G, 4G or other cellular standards, Internet and PTSN.

In another aspect, there is provided a format that is appropriate for a telecommunications message, the format selected from the group consisting of: a cell phone text message, a mobile phone short message service (SMS), an email, a telephone message and a twitter message.

In another aspect, determining determines that the audible alarm conforms to a specific alarm protocol as defined by governmental and/or industrial standards .

In another aspect, determining determines that the audible sound corresponds to a standardized alarm selected from the group consisting of: National Fire Protection Association (NFPA), an American National Standards Institute (ANSI), and Underwriters Laboratories (UL) or other governmental and/or industrial organizations defining life threatening alarms.

In another aspect, determining determines that the audible sound corresponds to an alarm selected from the group consisting of an NFPA 72 signaling code, an NFPA 720 standard, an ANSI S 3.41 standard , and a UL 217 standard or other governmental and/or industrial standards defining life threatening alarms.

In another aspect, determining determines that the audible sound corresponds to an alarm from a past, present or future generation of alarm.

In another aspect, there is provided learning that adjusts a detection parameter based on an environmental condition affecting the audible alarm.

In another aspect, the audible alarm is sensed and a signal over a wireless medium is relayed indicating that the audible alarm is sensed.

In another aspect, there is provided controlling in a first housing.

In another aspect, there is provided sensing, detecting and relaying in a second housing as a relay, separate from the first housing.

In another aspect, there is provided a plurality of sensors dispersed throughout a given area where said lives or property are threatened.

In another aspect, there is provided heterogeneous plurality of sensors dispersed throughout a given, environmentally monitored area.

In another aspect, there is provided a sensor employing a low power wireless transmitter to transmit the alarm detection signal in order to save power.

In another aspect, there is provided employing a logic that keeps most of the sensing, detecting and relaying circuit in inactive state in order to save power.

The various embodiments are also applicable and may be employed with any alarm or audible alarm and/or with any repeatable or recognizable audio pattern.

A simple and inexpensive method and apparatus are provided for reliable detection and identification of alarm sound along with the notification of a remote (off-site) user. The notification in one aspect is a direct notification, that is, does not use a professional notification service or operator, requires no subscription to such a third party, does not use remote computer to perform notification decision and does not store user data on a remote server. The direct notification may be routed through intermediate nodes and may include all information required for routing the notification without external control, such as by a notification service or operator. The notification may be in the form of a text message, an email message, a Twitter message or the like. In some embodiments, the notification could be by pre-recorded telephone call message.

A dedicated algorithm and/or electronic circuit(s) are provided to detect and identify an alarm sound from smoke, CO or other detectors and other types of alarms of various generations. This algorithm/circuit(s) uses wireless communication to interconnect between the alarm detection/identification circuit and a controller . The controller causes a text message (SMS) or/and email message or/and Twitter message or/and the like to be generated and sent to remote user via internet connected device or by cellular network connected device or by telephone land line or the like. The dedicated algorithm and/or electronic circuit(s) allow continuous operation of the apparatus with very low power consumption, resulting in extended battery life.

Now the operation of the system shall be described with reference to FIG. 8 that illustrates a monitored building 802, a telecommunications media 804, and a remote user location 806. One or more smart sensors 808 detect and identify an alarm and transmit a wireless signal to the controller 810. The controller 810 receives an alarm indication, activates a telecommunication device (e.g. PC, cellphone, phone) and controls or forwards a signal to the communication device to transmit an alarm message to the user.

In one variant, an Internet Connected Device 812 (e.g. household PC, tablet, smartphone) is provided to connect the controller to the telecommunications media. In another variant a Cellular Connected Device 814 (e.g. cellphone, GSM/GPRS module)) is provided to connect the controller to the telecommunications media. In another variant a Phone Dialer 816 is provided to connect the controller to the telecommunications media.

The controller 810 then controls a telecommunications device or transmitter to transmit an alert over a telecommunications network. In one variant, the telecommunications network is the internet 818. In another variant, the telecommunications network is a cellular network 820. In yet another variant the telecommunications network is a plain old telephone (POTS) or public service telephone network (PSTN) 822. The telecommunications transmitters may be of one or more telecommunications types as shown and may act singularly or in any combination. At the remote user location, there may be any type of receiving device including a PC 824, a cell phone or smart phone 826 or a telephone 828.

The user in one aspect has a nexus with the people or pets whose lives are threatened and/or property that is threatened. A nexus is provided, for example, as a family or friend relationship. A nexus may also be a monetary or ownership interest in the property that is threatened, such as a home owner, landlord, business owner, real estate investor, etc. Looked at another way, the user is not an independent operator working for a security monitoring company or does not have an economic connection, through employment or contract, with a 3^{rd} party or warning service.

The area that is protected is not limited to a house or residence but may include any area such as a mall, office space, car, fitness studio, or any enclosure. The solution presented here may be subdivided into different areas of an area or site. As explained in further detail, the solution proposed here employs a controller that transmits the alarm message directly to the user. In one arrangement, each sensor may have an identification information that is transmitted to the controller either independently from the alarm signal or included in the alarm signal.

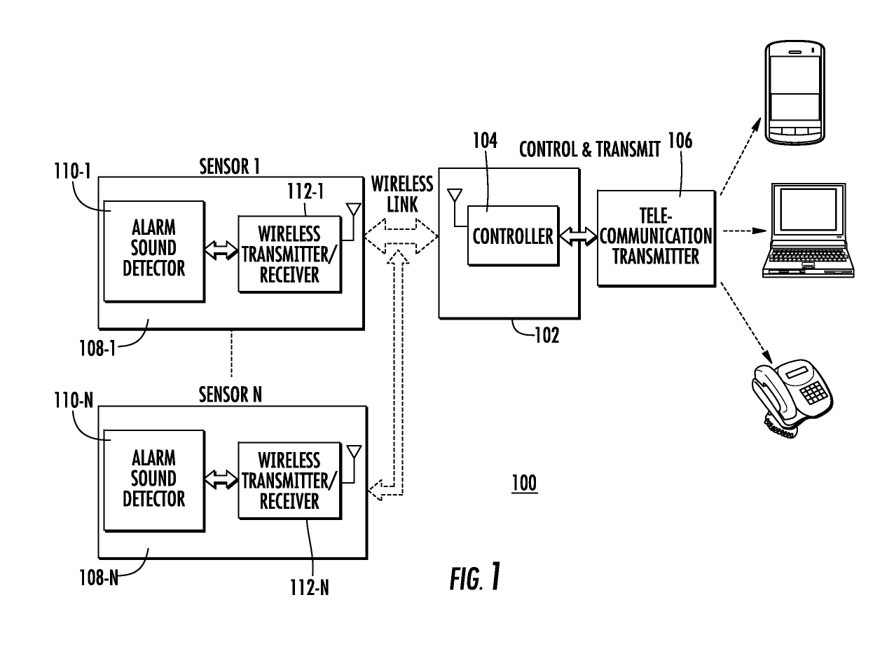

A more detailed description of the reliable detection, identification of detector alarm sound and notification device shall now be set forth with respect to FIG. 1. There is shown a system 100 for the detection and identification of an alarm. However, it shall be appreciated that the solution provided here may be elements comprising the system or combinations thereof. It shall also be appreciated that the detection of an audible alarm may be any type of alarm, such as smoke or CO alarm as already mentioned, and may also be an alarm for sounding an alert indicative of any threat or potential threat to lives or property of the user. These may additionally include, without exhaustion, fire, atomic radiation, carbon dioxide, security, freezing temperatures, oil leak, gas leak, etc.

To continue, a controller portion may be arranged in a first housing 102 and includes, for example, a controller 104. In another arrangement, the controller 104 could be an integrated part of an existing user telecommunication transmitter 106, such as a PC, for example. A sensing portion may be arranged in one or more sensors 108-1 to 108-N, each sensor arranged in a second housing, which may be separate from the first housing. In another arrangement, the sensor and controller are arranged in the same housing.

The sensors may include a microphone, for example. The sensing portion may include a sound detector 110-1 to 110-N and, in one aspect, may include a transmitter 112-1 to 112-N. The transmitter may be wireless. The transmitter may be a local low power transmitter, such as a WLAN transmitter that transmits using a low power wireless protocol, such as the ZigBee protocol. The sensors may be distributed throughout an area that is owned or under proprietorship, for example, by the user. Alternatively, the user has a vested or personal interest in the lives or property potentially under threat on the property or area. The sensor in one aspect may be a relay that relays the alarm condition to the controller.

It shall be appreciated that in one particular arrangement there is provided a single controller. This is in contrast to a centralized system where a controller is provided at the site where the alarm condition occurs and another controller is arranged at the remote central office; or a system where a controller and telecommunication transmitter are integrated into dedicated smoke detector or into alarm sensor In the case of multiple controllers power is wasted whereas in the present system a single controller is employed. Also , the sensor, the controller and the telecommunication transmitter are all on site of the residence or property where the alarm condition occurs.

Another disadvantage of the central system is that any modifications or adjustments to the system must occur through the remote central office. This not only costs money, but also is a hassle for the user. The user must contact the central office and request a modification, wait for the modification to be made and then pay for the change to the system. The hassle to the user is not at all trivial, but in reality is a major headache for owners who wish to protect their property. With the present solution, the user has absolute flexibility and control.

The present solution further offers greater security for the user's personal data. In a central office system, the user's private contact information, home address and perhaps credit card information is stored at a remote server and shared, sometimes over the public internet, with third parties. It is known that databases holding personal information including user account information are routinely hacked. With the present solution, however, the user never need to provide third party with his/her personal information since the controller is arranged on site where the alarm condition occurs.

The current embodiment saves power in a number of fundamentally significant ways. In one aspect already described, power consumption is drastically reduced by implementing a sleep mode, wherein only a small part of the sensor circuitry is kept active. The circuitry in sleep mode is then “awakened” when the sensor detects an alarm condition, such as an audible alarm.

In another example, a single controller transmits a signal representing the alarm condition. Implementing controllers in each sensor or relay multiplies the amount of power needed to operate such a system. Thus, reducing the number of controllers leads to power savings as well.

In another embodiment, battery power is conserved by powering the controller from an externally powered source, such as a computer or personal computer, or mobile switch, or telephone line.

Further, the sound detector 110 primarily performs identification of the audible alarm as a genuine alarm and, for example, distinguishes the audible alarm from noise such as an emergency vehicle in the background. For this purpose, there is additionally provided an algorithm, which may exist in the form of firmware, hardware or software. The algorithm may control or be executed by the sensor 108. A more detailed account of a possible algorithm is discussed below.

It shall be appreciated that providing a direct message to the user is advantageous. In this regard, no intermediary such as a notification service or operator is required and the alarm message is routed automatically. This has the advantage that the notification system is more robust, since the previous systems rely on intermediate human intervention. Should someone at the notification service fail to contact the emergency services, lives or property could be lost. Further, it shall be appreciated that no liability is owed to the user where a direct line of communication is provided. In the above example where the notification fails to contact the emergency service, the user may have a right of action against that third party. Further, the speed at which the user is notified is shortened dramatically since the third party is taken out of the communication chain. There is also the reduced expense associated with not using a third party to notify the user.

It shall also be appreciated that one or more aspects described with reference to FIG. 1 save power and are a green energy initiative. By providing the controller and power intensive telecommunication transmitter in a separate housing, the detection mechanisms, i.e., the sensor, may be multiplied and spread throughout an area. Since the sensors may not include the powerful telecommunications transmitter, the system as a whole and its parts save power dramatically. In one aspect, the sensors simply detect the audible alarm. In another aspect, the audible alarm notification and its parameters are forwarded or relayed to the controller. In a further aspect, the sensing portion includes an identification section.

Nonetheless, it shall further be appreciated that the solution provided is superior in saving lives and property. By providing the sensors throughout an area, coupled with smart identification, the solution provided better suited to detecting and alerting a remote user. In that sense, the user is considered remote when he or she is outside the region where the audible alarm can be heard. In another aspect, the user is remote when he or she can be alerted only through a telecommunications network. In any event, the remote user is more assured of receiving an alert related to a potential threat on the property.

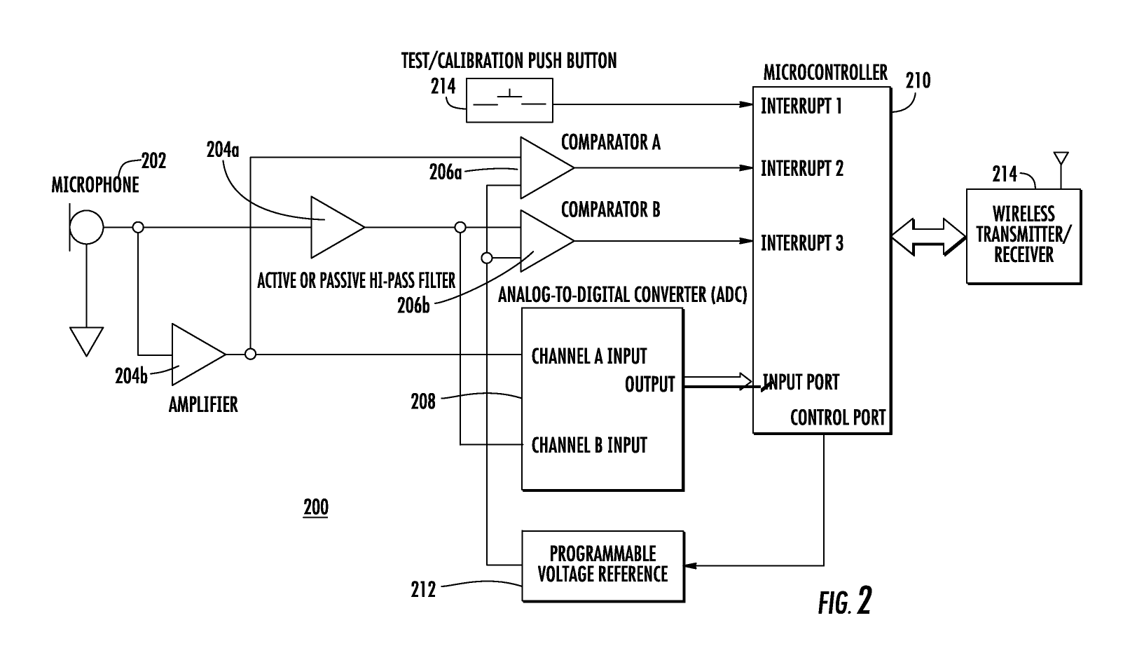

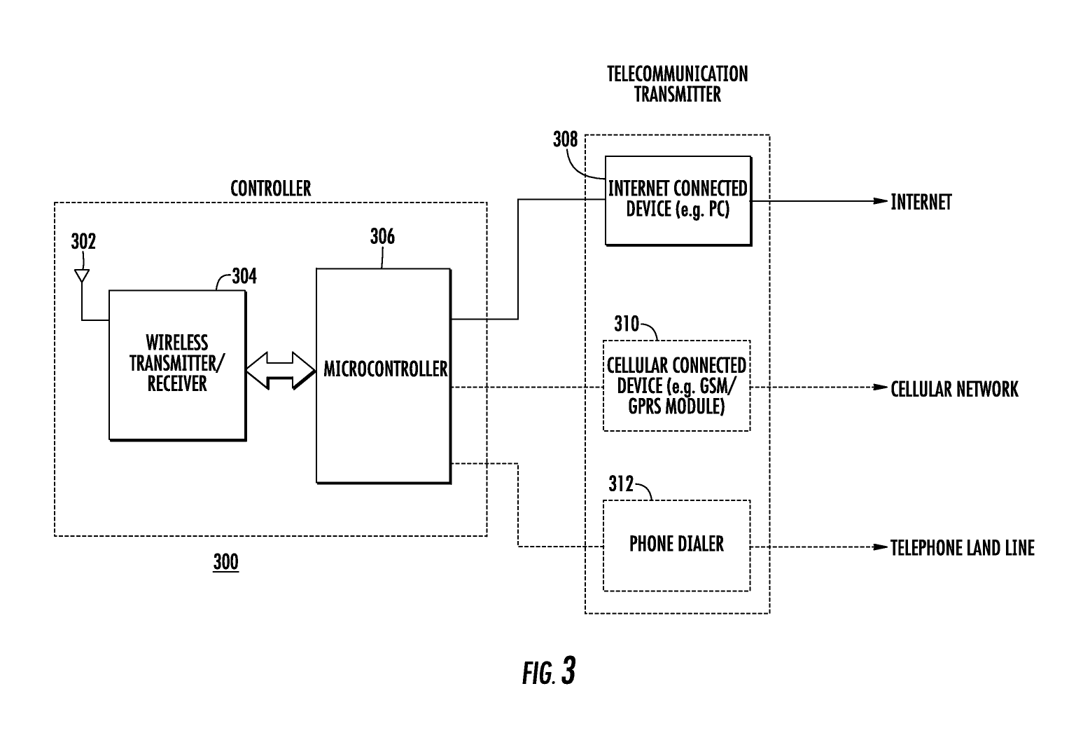

An algorithm and a circuit for identifying the audible alarm shall now be described with reference to FIG. 2. In one aspect, the algorithm is a dedicated algorithm and electronic circuit implementation, which allows for low power continuous operation making it especially useful for battery-operated small form factor embodiments. This also contributes to the power saving aspect of the solution provided here and advances governmental and worldwide green initiatives for saving power. A unique learning mode (calibration) may also be provided, which allows adjustment to the smoke or CO detector alarm sound levels at different locations.

An example sensor implementation is provided as generally shown by 200 with respect to FIG. 2. A microphone 202 senses the alarm and an output is fed to a detection and identification section. The output is fed simultaneously to amplifiers 204a and b. Then the amplified and filtered signals are sent to voltage comparators 206a and b and to analog-to-digital converter (ADC) 208. In order to support alert decision algorithm, both filtered (over 3 KHz) and unfiltered signals may be supplied.

Comparators 206 compare a microphone signal generated by the microphone to a predetermined or programmable Voltage Reference (Vref), which is programmed to the value corresponding to the required noise level, e.g. 85 db. The voltage reference may be provided by a feedback loop and provided by a voltage reference device 212. The signals of the comparators and the ADC are then forwarded to a microcontroller 210.

In one aspect, when the microphone signal exceeds a predetermined or programmed Vref value, an interrupt to microcontroller (MCU) is generated, the ADC is activated and an alert decision algorithm commences. If an alert decision is made the user can be notified by variety of means, including remote notification.

In another aspect, the comparators will be always active, but most of the sensor circuitry , including MCU, ADC and wireless transceiver 214 could be in an Idle or Sleep mode, and may continue to be such Idle or Sleep mode until interrupted. In other words, the unit further saves power by keeping only those components on that are essential for detecting an alarm. During sleep mode, some of the sensor circuitry is maintained in a listening state while the remainder of the circuitry, such as the wireless transmitter, is deactivated. In this manner, sleep mode extends the battery life.

As shall be more explained, when the Learning Mode/Calibration function is activated, the ADC may sample and measure the microphone signal output. The measured value is then used to reprogram the Vref value. In this manner, the Learning Mode trains the Sound Detector, thereby improving its response accuracy.

Further, an Alert Decision Algorithm may be provided. When the comparator detects a microphone signal which exceeds a preset level value, it interrupts the MCU. The MCU then makes an alert decision. The primary purpose of the alert decision algorithm is to mask out any unrelated noise and to detect only the real smoke or CO alarm noise.

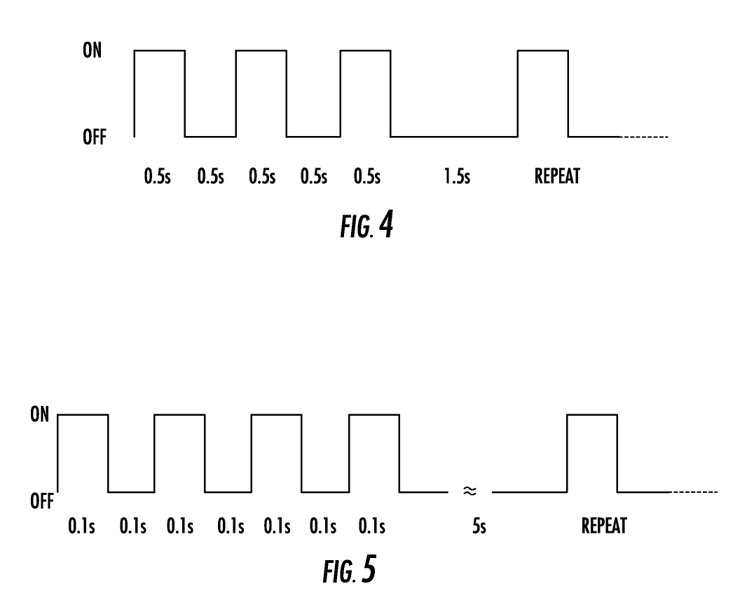

Returning for the moment to FIG. 1, the transmitter 106 in one aspect is a telecommunications transmitter, for transmitting signals over a telecommunications network. In one aspect, this is to be differentiated with local communication networks such as a LAN. For example, and as shown by the arrangement 300 in FIG. 3, the telecommunications network is of the type provided by a carrier network, such as POTS, PSTN, Internet , Mobile Carrier, etc. Thus, an antenna 302 of a wireless transceiver 304 in the controller 300 receives the alert signal from the sensor 108 and activates a microcontroller 306 in the controller 300. The controller 300 transmits an alarm message to a telecommunication device 308-312, in one example.

The controller 300 receives the alert signal and processes the signal according to, for example, the procedure provided above. In one aspect, the controller activates a telecommunication device (e.g. PC, cellphone, phone) to transmit an alarm message to the user. The controller can then control one or more of the telecommunication transmitters to transmit the notification message to the user. In one aspect, the telecommunication transmitter transmits the notification alert to the user directly. This may be over intermediate nodes, but the routing is not controlled or directed purposely by a third party such as a notification service or operator.

In one aspect, the transmitters 308 to 312 have all components necessary for the telecommunication transmission. In POTS or PSTN, for example as illustrated by 312, the transmitter includes the dialer for transmitting a telephone signal. In Internet, the transmitter 308 may include a DSL or cable gateway or dial-up modem. For Mobile Carrier, the transmitter 310 may include a mobile station transmitter. In any of these aspects, the transmitted message may be built by the controller or transmitter to include all necessary information for routing the notification alert to the user.

The Smoke or CO alarm may have a number of characteristics depending on the type of audible alarm. These may include the following:
it is active as long as smoke or CO is detected
its sound level is 85 dBA at 10 ft (defined by UL 217 standard)
its pitch is pure tone 3.2 KHz or higher (for currently installed alarms) or square wave with base frequency of 520 Hz (for 2014 and up alarms)

Further, in one example, an alarm sound level, envelope and/or pattern is detected. The alarm sounder (horn) pattern could be of following kinds:
Continuous, pure tone 3200 Hz or higher (pre-1996 smoke detectors)
T3 pattern—Temporal-Three, pure tone 3200 Hz or higher (NFPA 72 code and ANSI 53.41 standard) (FIG. 4)

T4 pattern—Temporal-Four, pure tone 3200 Hz or higher (NFPA 720 standard) (FIG. 5)

From Janurary 2014 alarms will employ T3 or T4 patterns with square wave 520 Hz signal (NFPA 72 code)

The algorithm may address all generations of the smoke and CO detectors including the following:
pre 1996 generation with continuous 3200 Hz or higher pattern current generation with T3 or T4 3200 Hz or higher pattern 2014 and up generation with T3 or T4 520 Hz pattern

In one example, the algorithm identifies three valid alarm patterns:
continuous high pitch (>3000 Hz) signal, sampled for period of time (10 sec in some embodiments)
T3—three consecutive pulses, regardless of pitch, occurring twice during sufficient period
T4—four consecutive pulses, regardless of pitch, occurring twice during sufficient period

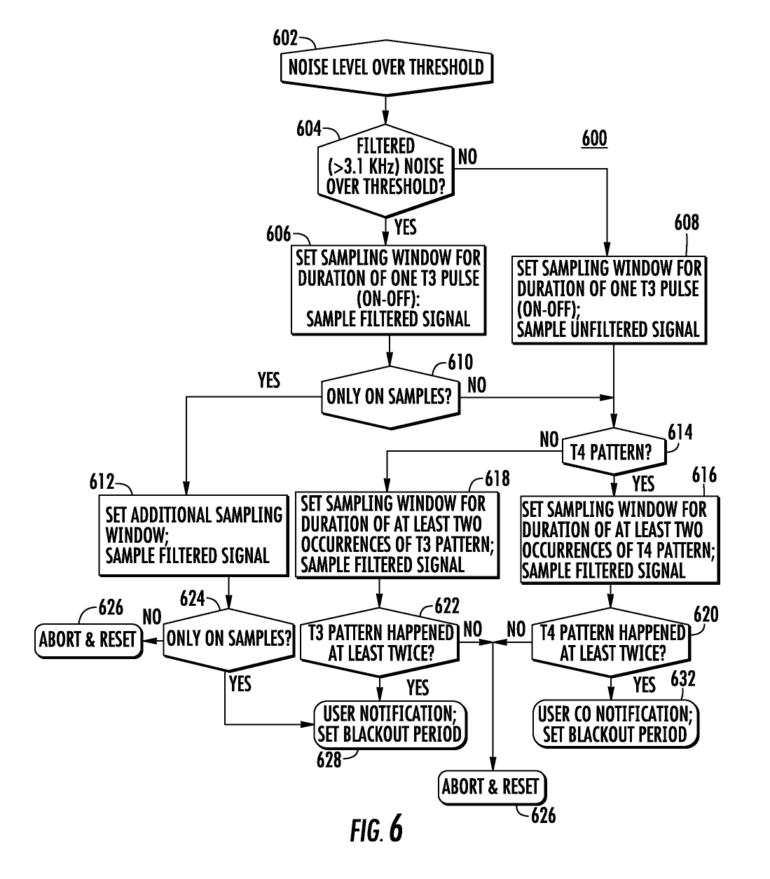

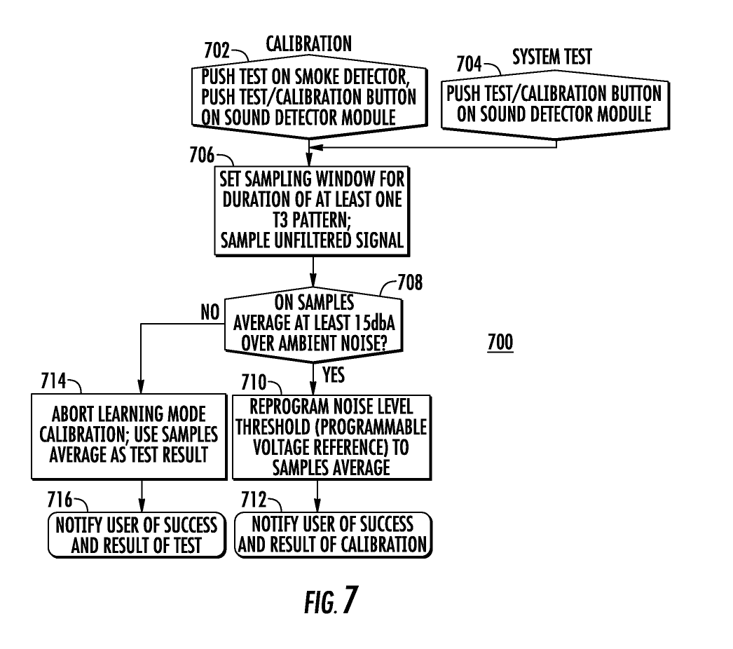

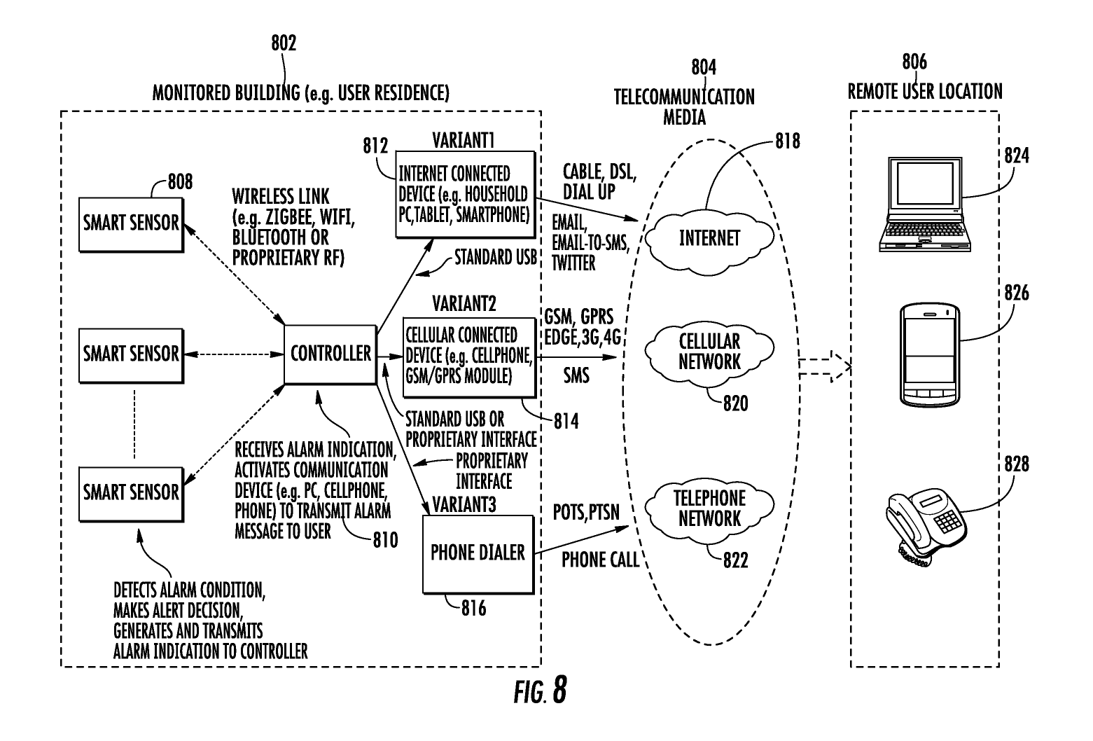

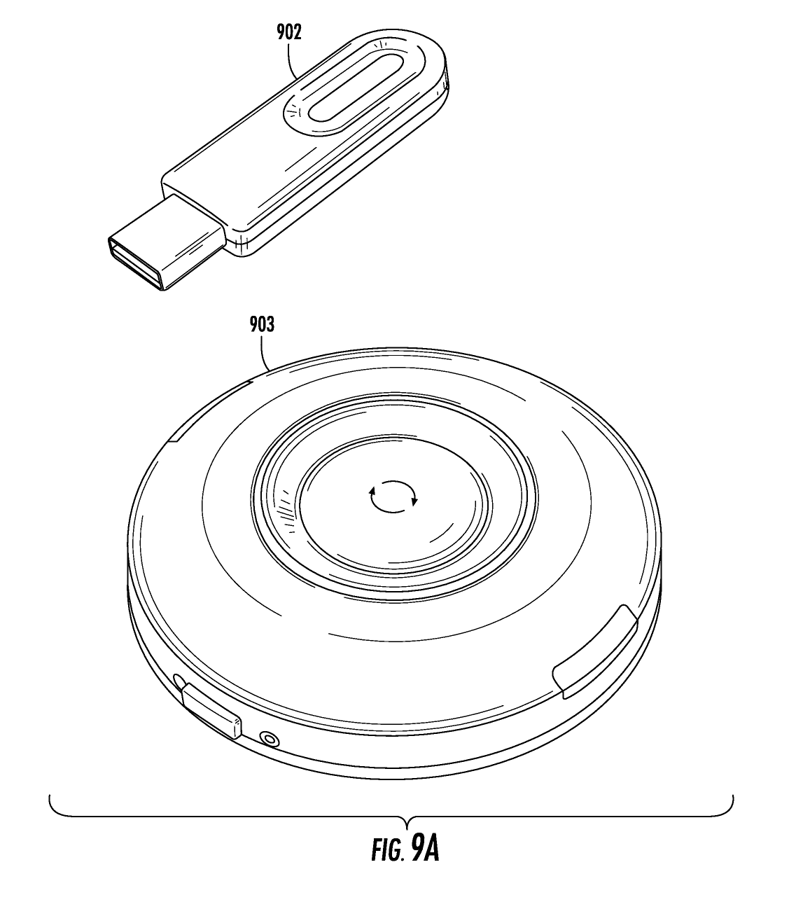

Now a detailed description of an example solution for the identification process 600 shall be set forth with respect to FIG. 6. In this example, a sequence trigger is employed.

For old and current generations of alarms, both filtered (>3 KHz) and unfiltered signals over a preset level will trigger a comparators interrupt to an MCU. For future (2014 and up) alarms, an unfiltered signal will trigger a comparator interrupt, see step 602/604.

The MCU will activate ADC sampling of the filtered signal 606. For future generations of alarms, it will activate sampling of the unfiltered signal 608. ON sampling means the signal is at or above a preset level (e.g. 85 dBA in some embodiments), and OFF sampling means the signal is below a preset level by at least 15 dBA. The NFPA 72 mandates that an alarm sound level be at least 15 dBA above ambient (in sleeping areas).

If for the first second (duration of one T3 pulse) there are only ON samplings 610, MCU will expect to receive only ON samplings for the additional predetermined time (e.g., 10 sec in some embodiments) to decide on a valid pattern 612. If any OFF sampling is received during this time 624, MCU will abort sampling and reset the ADC and comparators 626.

If during a predetermined time, for example the first second, there is an OFF sampling, the MCU will check for a T4 pattern (four pulses, each 100 ms ON-100 ms OFF) 614. If this pattern is identified, the MCU will sample for a sufficient amount of time (e.g., at least 12 sec) to identify the occurrence of at least two T4 patterns 616. If the pattern has not occurred, for example, 2 times, the MCU will reset the ADC and comparators 626.

If during the predetermined time, i.e., the first second, with OFF sampling the T4 pattern is not identified 618, the MCU will check for a T3 pattern 622 (three pulses, each 500 ms ON-500 ms OFF) during a sufficient time (at least 8 sec) to identify the occurrence of at least two T3 patterns 628. If the pattern has not been identified or has not occurred, for example, 2 times, the MCU will reset the ADC and comparators 626.

For future generations of alarms, when an unfiltered signal is sampled, the MCU will look only for the T3 and T4 patterns and will not check for a continuous alarm.

After any of the valid alarm patterns is identified, the MCU will initiate a user alert transmission and will disable the signal sensing for the duration of a “blackout” period (e.g., 30 minutes in some embodiments) 632. After the blackout period, the MCU will enable signal sensing and will return to normal state. This further saves power as the signal sensing is disabled.

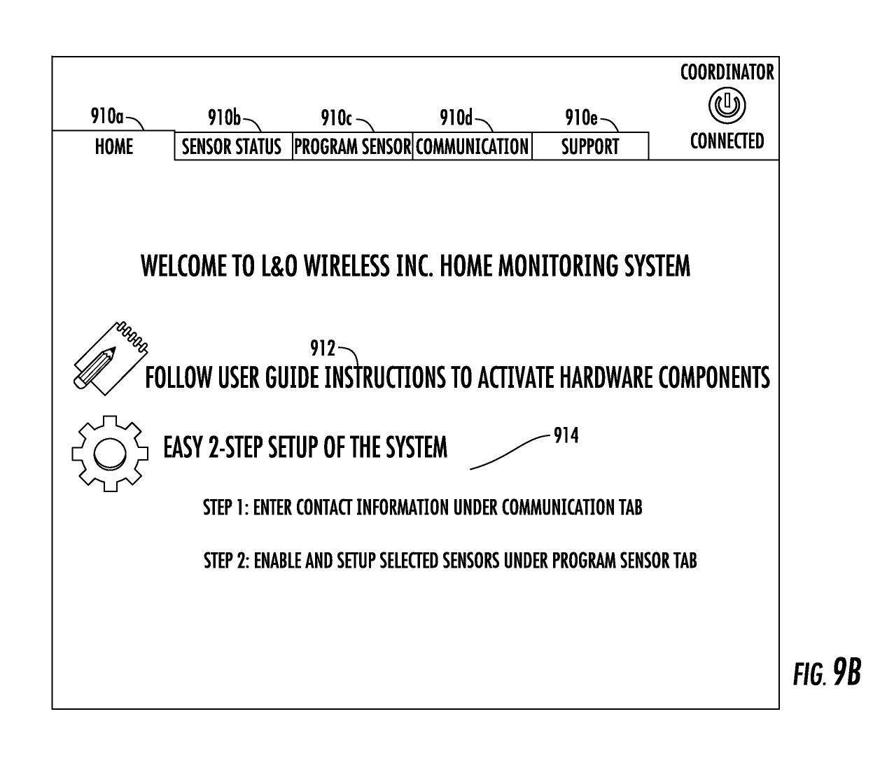

Further, the Learning Mode and system test function 700 shall now be described with respect to FIG. 7. The UL 217 standard requires the residential smoke or CO alarm level to be 85 dBA at 10 ft (3m). The Sound Detector will be preset to this level and its recommended location will be within 10 ft of a smoke or CO detector with an unobstructed line of sight.

If for any reason a user decides to position the sensor in a different location, it will be possible to calibrate the sensor to the specific alarm level at the chosen location, acknowledging that this might increase the occurrences of false notifications.

A calibration procedure may make use of the standard test button on the smoke or CO detector and the Learning Mode (Test/Calibration) button on the Sound Detector Module and will proceed as following:

Push test button on the smoke or CO detector, activating alarm sounder, 702.

Push Learning Mode (Test/Calibration, FIG. 2) button on Sound Detector Module.

The ADC will sample the microphone signal for a duration of the T3 pattern (4 seconds) 706. If the ON samplings average is at least 15 dBA over the measured ambient noise 708, the average will be used to reprogram the Voltage Reference 710. Further, the user may be notified of the success of the calibration 712 through any suitable indication, i.e., light emitter, audible sound, or status on a computer or LCD screen, etc.

If the noise level is less than 15 dBA (or other threshold in different embodiments) over the measured ambient noise, then no calibration is performed 714 and the user is notified of the results 716. The user may then reposition the Sound Detector Module closer to the alarm source. In this case, the Sound Detector Module may then be recalibrated.

The System Test procedure 704 is similar to a calibration procedure except that the smoke or CO detector alarm is not activated. In this case, Sound Detector Module measures the ambient noise and reports the results to the user.

With the solution provided, there is a single controller per system, which employs wireless communication to any number of sensors and which generates remote user notification messages by means of text (SMS) message, email message, Twitter message, telephone message, or the like. In one embodiment, the controller connects to an internet connected computer or tablet or similar device. The connection could be, for example, through a ubiquitous Universal Serial Bus (USB) port. In another embodiment, the controller could be integrated into a hardware or a software of an existing computer at user location.

The controller may generate the user notification. In this case, for example, the controller invokes a dedicated resident computer program, which in turn activates a messaging application such as a native mail client program or Twitter application. Subsequently, in this example, an email message is generated through a mail program, a Twitter message through Twitter application, or a text message through an email-to-text option provided by cellular providers.

The controller and a corresponding transmitter provide that a message signal is directly sent to the user or owner of the property through routing or one or more nodes. In the examples given above, the message signal is provided with all routing information necessary to route the message signal through the internet or other telecommunications network to the end user. In other words, a third party or monitoring agency does not monitor the message signal and route the information for the user. Instead, the user or owner is directly sent the message signal. In other embodiments, the controller connects directly to a cellular network by means of a dedicated GSM/GPRS module with installed SIM card and cellular network subscription. In this embodiment only a text (SMS) message is generated. In another embodiment, controller connects directly to a telephone land line by means of phone dialer. In this embodiment, only a telephone message is generated.

As already explained, the sensor or sensors may each include different identification information. In that case, the controller may track hundreds of sensors and distinguish between the different sensors. The controller may also have the capability to map the particular sensor or sensors to a location with the site. In this manner, the present solution here may alert the user not only of the alarm message directly but also the location within the site based on such mapping.

Further, the controller is arranged in a first housing. The sensor for detecting the audible alarm may be arranged in a separate housing that is remote from the first housing. The sensor may be provided with a corresponding transmitter, such as a wireless transmitter, that transmits a detection signal to the first housing. In that case, the sensor may be considered as a relay that relays an alarm condition to the controller. In one aspect, the sensor may simply include an audible sound pattern detection circuit. In this case, the controller includes an algorithm for determining if the audible alarm conforms to a predetermined alarm format. Again the relay is, thus, a simplified device, which may be placed in several locations and at relatively low cost.

In a system arrangement, there are provided a plurality of such sensors that are distributed throughout an area where lives and property are threatened. In this manner, it shall be appreciated that the sensors save power because they do not include the power intensive controller or telecommunication transmitter. By contrast, the wireless transmitters in the sensors are relatively low power consumption devices. In other words, since only one controller is needed for a given area, the solution provided does not require a large power draw. In addition, and as further explained, the sensor or sensors may be maintained in a sleep mode as their default condition, thereby further conserving power.

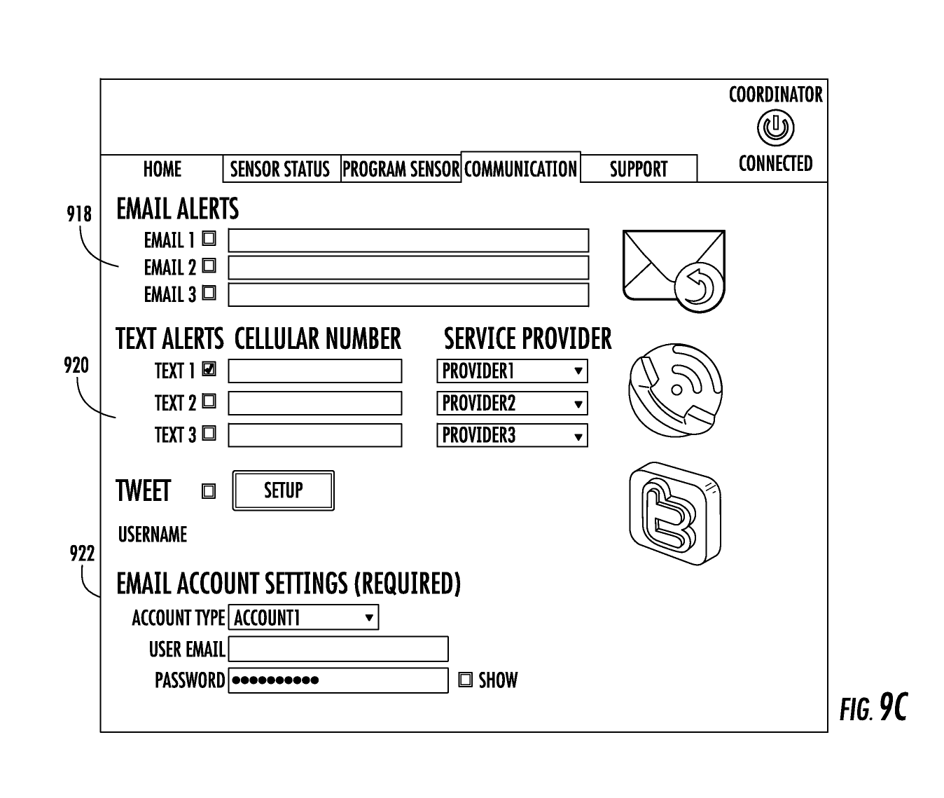

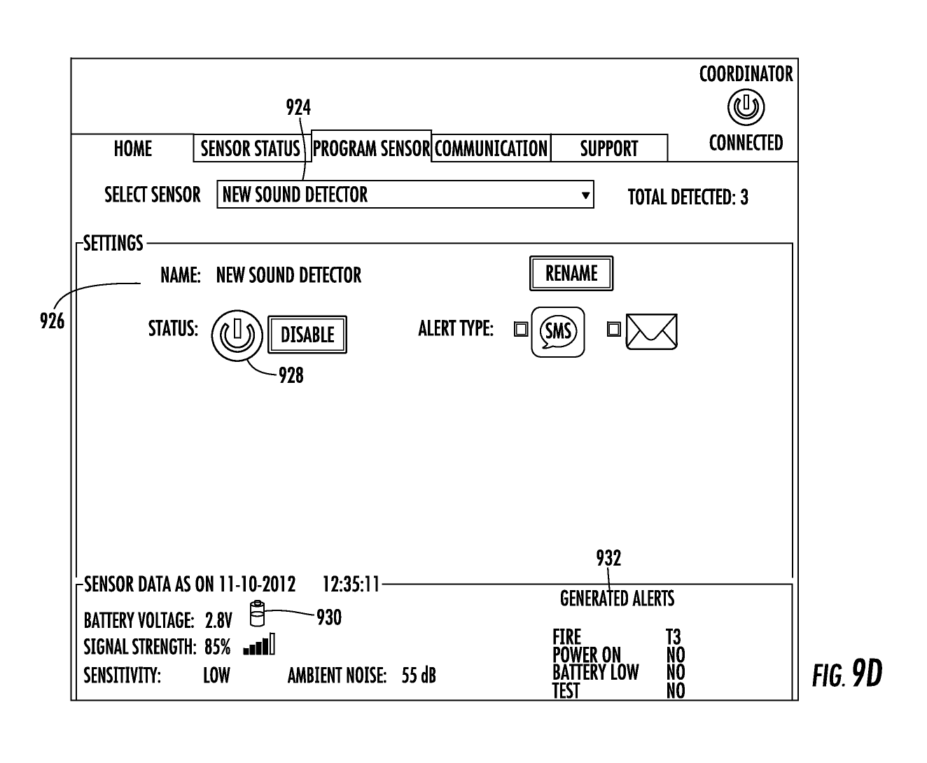

FIGS. 9a-d illustrate various components of the alarm notification system. FIG. 9a illustrates examples of manufactured and assembled components. There is shown an example in FIG. 9a of a controller implemented as USB stick 902 that is configured to include a USB connection to a telecommunication device such as computer or other telecommunication transmitter. Instead of a USB stick, a USB dongle or other similar device may be utilized. While a USB connection is suitable for a personal computer as the majority of PC's currently include such connection, the actual type of connection may be of any type, such as a Firewire connection, a serial or parallel connection, Ethernet, WiFI, DSL, POTs, etc. A person skilled in the art of interfacing connections will readily understand which of the well-known interfaces to use, many of which are off-the-shelf solutions. In addition, any protocol may be used to connect to the host device. These may include protocols, such as USB 2.0 or 3.0, Firewire, Serial or Parallel, Ethernet, WiFi, DSL, POTs, etc. The connection may also include a custom connection to the host device, such as that which may be needed to connect to a cell phone or smart phone.

The examples shown in FIG. 9a may include the proposed solution in its entirety or any portion of its constituents. For example, the controller alone may be integrated into the illustrated USB stick or card. In the alternative, the transmitter or receiver, or portions thereof may be integrated into the shown examples. In another variation, the examples or variations thereof may include a receiver to receive an alarm signal and a controller, which may be similar to the controller discussed earlier. There may also be an interface to interface to the host device, such as a PC. In one sense, the examples shown in FIG. 9a may be thought of as an external device or a device connectable to a host device, such as cards, interfaces, or daughter boards, for example. The device may be inserted into a PC or integrated within its housing.

The examples of FIG. 9a illustrate an additional power advantage, namely that the host device may power the external or card device. Further, the host device may be configured to handle the transmission of the message to the user. In some examples illustrated, the controller and/or the transmitter require the most power. In the case where an external device is to be used with a host device, the host device may be configured to power the external device. In that case, the external device does not require any additional power source or adapter to power the controller and/or transmitter. In the case of a USB stick or dongle, for example, it is known that computer USB ports are equipped with a power supply, provided through a power pin, in order to power the USB stick or dongle. Similarly, in the case of a 3G or 4G network, or POTs network these networks or network racks also provide power. In the POTs example, a power pin for the RJ11 jack is typically provided and powered by the telephone company.

In another aspect, the solution provides configuration devices and methods. The configuration may be for the transmission of the alarm message to the user. There may also be provided the ability to configure the alarm, to insert the destination or routing information for routing to the user, or ability to obtain status information of the system or alarms. Further, there may also be provided indicators that inform the user of the amount of power left in the batteries, a status of the sensor, or status and configuration of the algorithm such as that described above. In addition, system configuration information may also be provided. Icons also may also be displayed in order to provide a visual cue or status such as battery indication, wireless LAN set up, etc, or router or gateway setup. Further, maintenance and support contact information or an internet link to a repair service may also be provided.

The devices and methods for configuration may be provided as software, firmware or hardware. They may, for example, be uploaded prior to sale or uploaded and/or reconfigured by the user. In the case of the USB stick, for example, the host device can include a configuration application. The configuration application may be provided on separate disc but also may be provided in the external device, e.g., USB stick, and uploaded to the host device either automatically or manually by the host device user.

FIG. 9a further illustrates a sensor 903 which is shown in the figure in the form of a separate housing. The sensor and controller, on the other hand, may be in a single housing. The sensor may be in the form of a disk. The housing of the sensor 903 in FIG. 9a resembles that of a typical fire alarm. The shape of the housing may, however, be in a different form. In addition there may be a test and/or configuring functionality incorporated with the sensor for testing or configuring the sensor.

In regards to the above examples, the configuration may be a configuration of the host device. FIGS. 9b-d illustrate examples of a device and process for configuring or programming a host device. There may be, for example, a graphical user interface (GUI). Such a GUI may include tabs 910a-e as shown in the FIGS. 9b-d. One tab may be a Home Tab 910a including a home screen with basic information. Another may be a Sensor Status Tab 910b with information to indicate a status of the sensor. Another tab may be a Program Sensor Tab 910c that allows the user of the host device to program the sensor. Another tab may be a Communication Tab 910d to set communication settings. Another tab may be a Support Tab 910e to provide support contact information.

The Home Tab 910a shown in FIG. 9b, for example, includes information how to set up the alarm system. Here are shown steps 912 that guide the user of the host device on how to set up the alarm system. Such guidance may include directions how to set up the contact information by clicking on the Communications Tab. It may also include directions 914 how to enable and set up selected sensors by clicking on the Sensor Tab.

The Communications Tab 910d takes the user to a different screen illustrated by FIG. 9c. This screen may include buttons to select the type of communication, for example email 918 or text 920 message or tweet. There may also be dialogue boxes to include access codes, such as user information and passwords. An account type 922 may also be provided to select a type of account, such as a cloud account. Further, a service provider may be selected, such as one of several known Telco networks, such as AT&T or Vodafone.

The Program Sensor Tab 910c takes the user to a different screen illustrated by FIG. 9d. This screen may include a button to select the sensor 924. The user of the host device then has an option to select the sensor desired to program. There may also be the ability provided to name the various sensors 926. The type of alert, for example, SMS or email may be selected. An ability to enable or disable 928 the selected sensor may be provided. A status for each selected sensor may also be provided on this tab, such as battery strength 930, signal strength of the WLAN, sensitivity, noise, for example. There may also be the ability to see the generated alerts 932, including a fire alert (T3, etc), a power on alert to alert when the power is toggled, a low battery alert to alert when the battery is low, or a test alert to indicate that the sensor and corresponding circuitry performed test procedure. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. An apparatus comprising:
a sensor that detects an alert condition threatening lives or property;
a controller that generates a signal in response to receiving an alarm indication from the sensor, the alarm indication indicative of an alert condition threatening lives or property;
a transmitter that directly transmits a message signal in response to the signal generated by the controller to a remote telecommunication device that is operated by a user; and
wherein the controller, the sensor, the alert condition and the transmitter are all on-site in the same location.

2. The apparatus of claim 1, wherein the sensor is configured to detect the alarm indication from an audible alarm and respond by sending an alarm indication signal to the controller.

3. The apparatus of claim 1, wherein the message signal includes routing information necessary to route the message signal through a network having multiple nodes to the telecommunication device.

4. The apparatus according to claim 1, wherein the routing information routes the message signal over a telecommunications network selected from the group consisting of: EDGE, GSM, GPRS, 3G, 4G or other cellular standards, Internet and PTSN.

5. The apparatus according to claim 1, wherein the message signal is configured to have a format appropriate for a telecommunications message, the format selected from the group consisting of: a cell phone text message, a mobile phone short message service (SMS), an email, a telephone message and a twitter message.

6. The apparatus according to claim 1, wherein the transmitter is selected from the group consisting of: a cellular transmitter, a phone dialer, a computer device connected to an Internet network through a DSL gateway or a cable gateway or a dial up modem.

7. The apparatus according to claim 1, further comprising a sensor that senses and detects the audible alarm; and transmits a wireless signal to a controller in response to detecting the audible alarm;
wherein the controller is arranged in a first housing; or wherein the controller is integrated into the hardware or software of a telecommunication transmitter such as existing user computer located in the house; and
wherein the sensor is arranged in a second housing, separate from the first housing.

8. The apparatus according to claim 2, further comprising logic and/or algorithm that determines that the audible alarm conforms to an alarm protocol.

9. The apparatus according to claim 2, wherein the sensor is configured to determine that the audible alarm corresponds to a standardized alarm selected from the group consisting of: National Fire Protection Association (NFPA), an American National Standards Institute (ANSI), and Underwriters Laboratories (UL) or other governmental and/or industrial organizations defining life threatening alarms.

10. The apparatus according to claim 2, wherein the sensor is configured to determine that the audible sound corresponds to an alarm selected from the group consisting of an NFPA 72 signaling code, an NFPA 720 standard, an ANSI S 3.41 standard , and a UL 217 standard or other governmental and/or industrial standards defining life threatening alarms.

11. The apparatus according to claim 2, further comprising learning logic that adjusts a detection parameter used to detect the audible alarm based on an environmental condition affecting the audible alarm.

12. The apparatus according to claim 2, wherein the sensor employs a low power wireless transmitter to transmit alarm detection signal in order to save power.

13. The apparatus according to claim 2, further comprising logic is provided that maintains a portion of the sensor, including the wireless transmitter in inactive state in order to save power.

14. A method comprising the steps of:
detecting an alarm indicative of an alert condition threatening lives or property; and
transmitting a message signal in response to the detecting of the alarm directly to a remote telecommunication device that is operated by a user;
wherein the detecting and transmitting both occur on-site where the alert condition takes place.

15. The method of claim 14, further comprising the step of detecting the alarm from an audible alarm.

16. The method of claim 14, further comprising the step of including routing information associated with the message signal necessary to route the message signal to the telecommunication device.

17. The method according to claim 15, further comprising a step of determining that determines that the audible alarm conforms to a specific alarm protocol as defined by governmental and/or industrial standards.

18. The method according to claim 15, further comprising the step of learning to adjust a detection parameter used to detect the alarm based on an environmental condition affecting the audible alarm.

19. The method according to claim 15, further comprising the steps of:
sensing the audible alarm;
detecting the audible alarm to be indicative of an alert condition threatening lives or property; and
transmitting a signal over a wireless medium indicating that the audible alarm is detected.

20. The method according to claim 19, further comprising the step of employing logic that keeps a portion of the sensing, detecting and the wireless transmitting in inactive state to save power.
